(19) United States
(12) Patent Application Publication
(10) Pub. No.: US 2013/0021385 A1
(43) Pub. Date: Jan. 24, 2013

(54) LCD DEVICE AND BLACK FRAME INSERTION METHOD THEREOF

(71) Applicant: Hung-lung Hou, Shenzhen (CN)

(72) Inventor: Hung-lung Hou, Shenzhen (CN)

(73) Assignee: SHENZHEN CHINA STAR OPTOELECTRONICS TECHNOLOGY CO, LTD., Shenzhen, Guangdong (CN)

(21) Appl. No.: 13/375,632

(22) PCT Filed: Sep. 22, 2011
(86) PCT No.: PCT/CN2011/079983

§ 371 Date: Dec. 1, 2011

(30) Foreign Application Priority Data
Jul. 22, 2011 (CN) 201110207351.6

(51) Int. Cl. G09G 3/36; G09G 5/10

(52) U.S. Cl. 345/690; 345/90; 345/92

(57) ABSTRACT

The present invention discloses an LCD device, which includes N scan lines, N rows of first and second pixel units alternately arranged, N/2 auxiliary scan lines, and switches. The N/2 auxiliary scan lines are respectively disposed between an (i)th row of the first pixel units and an (i+1)th row of the second pixel units, in which N is a positive integer greater than 1, and i is an odd number and 1≦i<N. The switches are disposed in the auxiliary scan lines for controlling a conduction between the common electrode and the pixel electrode in the (i)th row and the (i+1)th row of the pixel units. Moreover, a black frame insertion method is also discloses. Moments of driving the auxiliary scan lines are later than moments of driving the scan lines. Frame rates do not need to be increased, which makes twists of liquid crystal more stable.

### FIELD OF THE INVENTION

The present invention relates to a display device, and more particularly to a liquid crystal display (LCD) device and a method of a black frame insertion for the LCD device.

### BACKGROUND OF THE INVENTION

A liquid crystal display (LCD) shows different brightness or grayscales by twisting the liquid crystal molecules to control light transmittance. Compared with a cathode ray tube (CRT) display which displays with an impulse type, the LCD is driven by a continuous voltage holding manner (hold type). Because the twists of the liquid crystal molecules change continuously, response speed for performing dynamic images in the LCD is slower than that in the CRT display. Thus, a motion blur occurs in the LCD when displaying dynamic images.

In order to solve the problem of the motion blur, a black frame is utilized to be inserted between two frames in displaying the dynamic images, thereby generating a displaying manner similar to the impulse type for the CRT display. This approach eliminates the motion blur that is generated by persistence of vision for a user seeing the dynamic images. The solution is called a black frame insertion technology. It generally requires twice frame rate to renew the frames for using the black frame insertion technology to display the images in the prior art, that is, a scanning frequency is changed from 60 Hz into 120 Hz. That is to say, image voltages are provided for pixels in a frame period, and a black grayscale voltage (i.e. black frame) is provided for the pixels in another frame period. It can be seen from the foregoing that transitions of the grayscales of the pixels all start from the black grayscale voltage, which makes the twists of the liquid crystal molecules more stable.

However, the frame rate of a large LCD or a three-dimensional (3D) display needs to be further increased, such that a period for the transitions of the grayscales of the pixels is very short. As a result, the response time of the liquid crystal molecules is insufficient to reach the desired state, which leads to deterioration of image quality.

### SUMMARY OF THE INVENTION

Accordingly, an objective of the present invention is to provide an LCD device and a black frame insertion method therefor to overcome the drawbacks of the above-mentioned prior art.

To achieve the foregoing objective, the technical solution of this invention is implemented as follows. The LCD device includes N scan lines, N rows of first pixel units and second pixel units alternately arranged, N/2 auxiliary scan lines, and a plurality of switches. Each row of the first pixel units and each row of the second pixel units respectively correspond to a scan line, and each pixel of the first pixel units and the second pixel units includes a pixel electrode and a common electrode. The N/2 auxiliary scan lines are respectively disposed between an (i)th row of the first pixel units and (i+1)th row of the second pixel units, in which N is a positive integer greater than 1, i is an odd number and 1≦i<N. The switches are disposed in the N/2 auxiliary scan lines for controlling a conduction between the common electrode and the pixel electrode in the (i)th row of the first pixel units and the (i+1)th row of the second pixel units.

Preferably, the switches are a plurality of thin film transistors. Each of the thin film transistors has a gate, a source, a first drain, and a second drain, wherein the gate is the auxiliary scan line, and wherein the source, the first drain, and the second drain are disposed on the auxiliary scan line. Specifically, the source is electrically coupled to the first common electrode located on the (i)th row of the first pixel units and coupled to the second common electrode located on the (i+1)th row of the second pixel units. In addition, the first drain is electrically coupled to the first pixel electrode located on the (i)th row of the first pixel units, and the second drain is electrically coupled to the second pixel electrode located on the (i+1)th row of the second pixel units.

In one preferred embodiment, signals of the first common electrode and the second common electrode are simultaneously inputted the first pixel electrode and the second pixel electrode when the gate is at a high level. Pixel units corresponding to the first pixel electrode and the second pixel electrode are black.

To achieve the foregoing objective, the technical solution of this invention is implemented as follows. The black frame insertion method for an LCD device is provided. The LCD device includes N scan lines, N rows of first pixel units and second pixel units alternately arranged, N/2 auxiliary scan lines respectively disposed between an (i)th row of the first pixel units and an (i+1)th row of the second pixel units, and a plurality of switches being disposed in the N/2 auxiliary scan lines. Each pixel of the first pixel units and the second pixel units includes a pixel electrode and a common electrode, in which N is a positive integer greater than 1, and i is an odd number and 1≦i<N.

The black frame insertion method comprises: driving the alternately arranged N rows of the first pixel units and the second pixel units sequentially through the N scan lines, so that the first pixel units and the second pixel units corresponding to the alternately arranged N rows of first pixel units and second pixel units display predetermined images; and driving the switches sequentially through the N/2 auxiliary scan lines, when the auxiliary scan lines disposed between the (i)th row of the first pixel units and the (i+1)th row of the second pixel units is driven, the common electrodes and the pixel electrodes located on the (i)th row of the first pixel units and the (i+1)th row of the second pixel units being conducted by the switches thereon, wherein moments of driving the auxiliary scan lines are later than moments of driving the scan lines.

Preferably, the moment of driving the auxiliary scan line located between the (i)th row of the first pixel units and the (i+1)th row of the second pixel units is half a frame period later than the moments of driving the (i)th or (i +1)th scan line.

Compared with the prior art, the LCD device of the present invention has the auxiliary scan lines for the signal of the common electrode being inputted into the pixel electrode, thereby achieving the black frame insertion effect, Moreover, in accordance with the black frame insertion method of the present invention, after the (i)th row of the first pixel units display the predetermined images, the (i)th auxiliary scan line can be driven after the half frame period for performing the black frame insertion process of the (i)th row of the first pixel units and the (i+1)th row of the second pixel units. It can be seen from the foregoing that the frame rate does not need to be increased, and the transitions of the grayscales of the pixels all start from the black grayscale voltage, which makes the twists of the liquid crystal more stable.

It is to be understood that both the foregoing general description and the following detailed description of the present invention are exemplary and explanatory and are intended to provide further explanation of the invention as claimed.

DESCRIPTION OF THE DRAWINGS

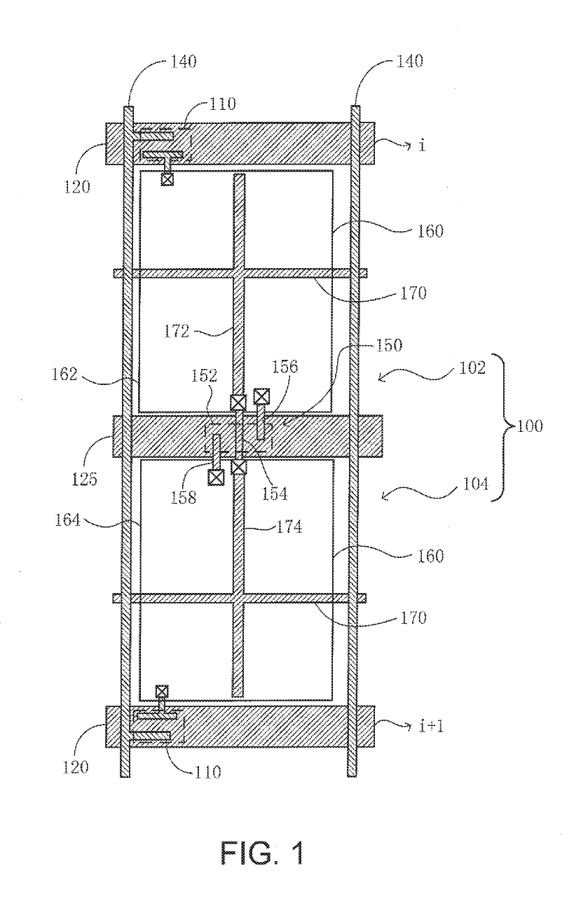

FIG. 1 is a schematic drawing illustrating pixel structures of an LCD device according to one preferred embodiment of the present invention;

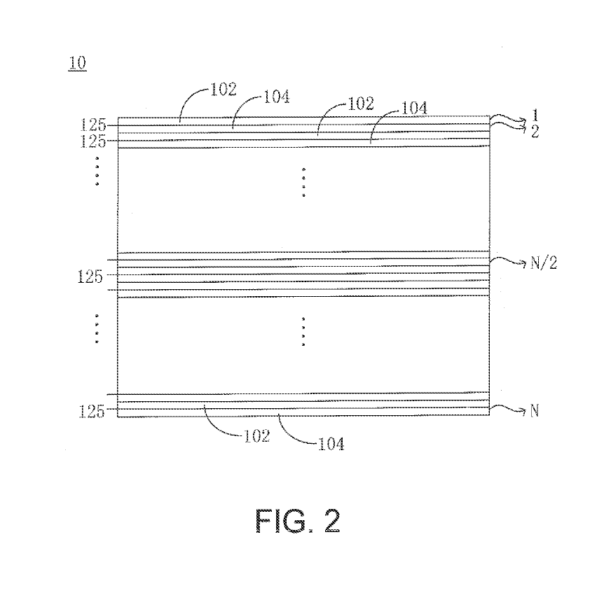

FIG. 2 is a schematic drawing illustrating an active area of the LCD device according to one preferred embodiment of the present invention;

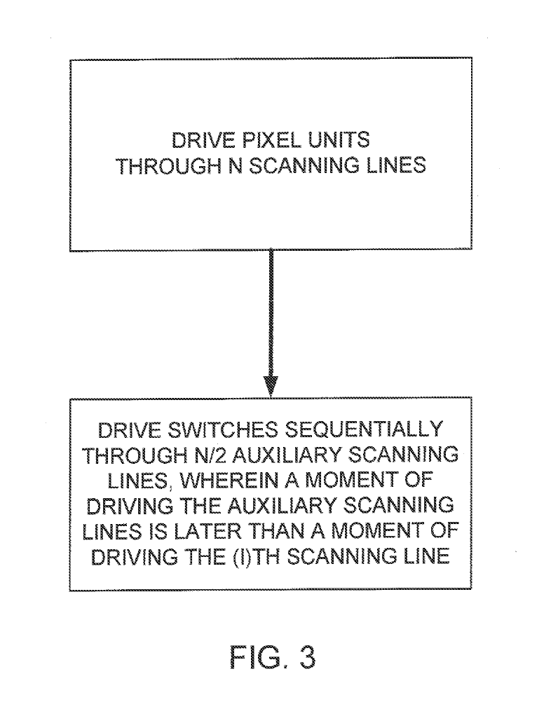

FIG. 3 is a flow chart illustrating a black frame insertion method according to the preferred embodiment of the present invention;

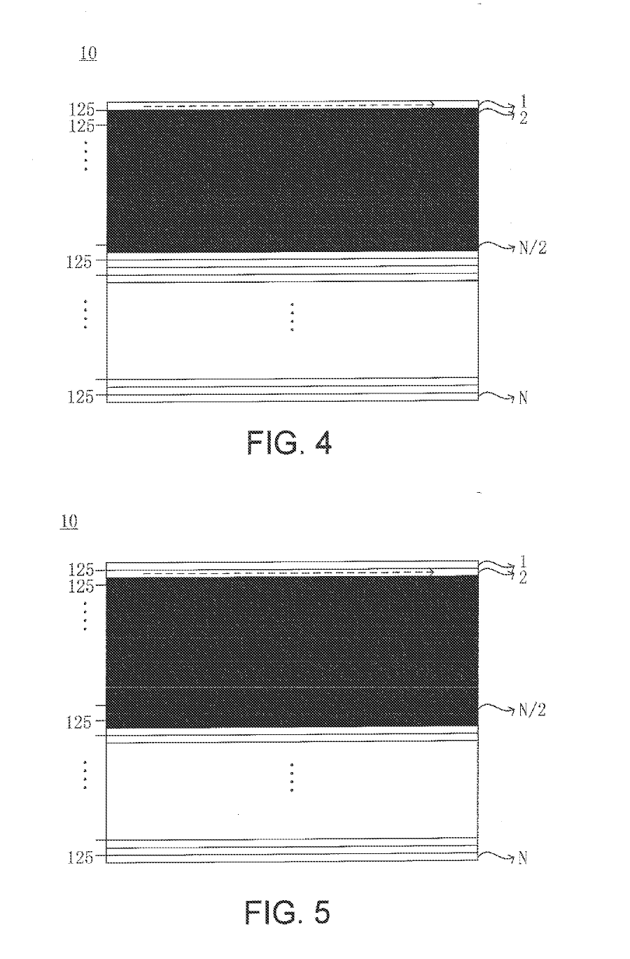

FIG. 4 is a schematic drawing illustrating the black frame insertion process of an active area according to one preferred embodiment of the present invention;

FIG. 5 is a schematic drawing illustrating the black frame insertion process of an active area according to one preferred embodiment of the present invention;

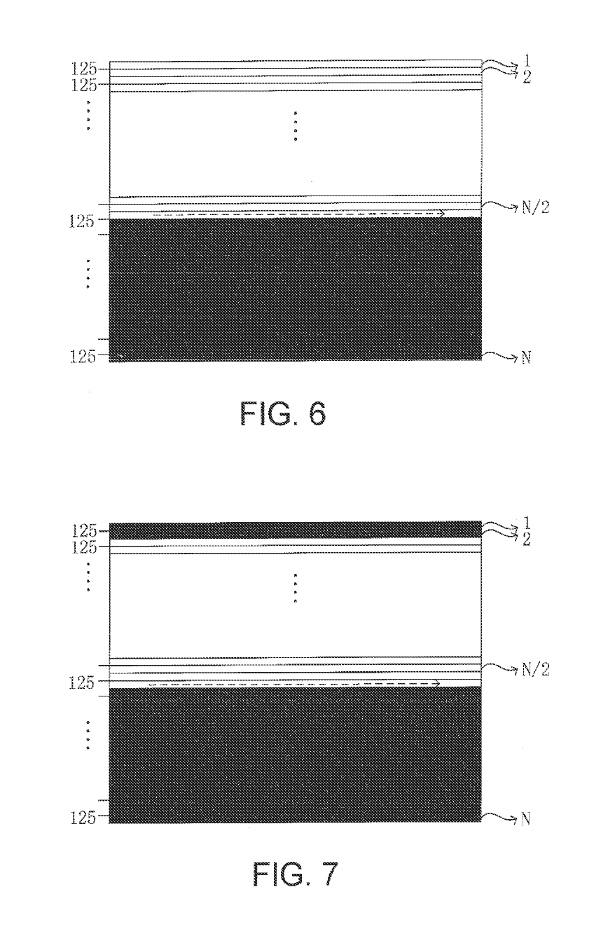

FIG. 6 is a schematic drawing illustrating the black frame insertion process of an active area according to one preferred embodiment of the present invention; and

FIG. 7 is a schematic drawing illustrating the black frame insertion process of an active area according to one preferred embodiment of the present invention.

### DETAILED DESCRIPTION OF THE PREFERRED EMBODIMENTS

Referring to FIG. 1 and FIG. 2, FIG, 1 is a schematic drawing illustrating pixel structures of an LCD device according to one preferred embodiment of the present invention, and FIG. 2 is a schematic drawing illustrating an active area of the LCD device according to one preferred embodiment of the present invention. The LCD device comprises N scan lines 120, N rows of first pixel units 102 and second pixel units 104 alternately arranged, N/2 auxiliary scan lines 125, and a plurality of switches 150. As shown in FIG. 2, the alternately arranged N rows of the first pixel units 102 and the second pixel units 104 form the active area 10 of the LCD device. Each row of the first pixel units 102 includes a plurality of the first pixel units 102, and each row of the second pixel units 104 includes a plurality of the second pixel units 104.

Specifically, a first row of the first pixel units 102 corresponds to a first scan line 120, and a second row of the second pixel units 104 corresponds to a second scan line 120, and a third row of the first pixel units 102 corresponds to a third scan line 120, and a fourth row of the second pixel units 104 corresponds to a fourth scan line 120, and so on. It should be noted that there are the first pixel units 102 and the second pixel units 104 between the first scan line 120 and the second scan line 120, as the (i)th scan line and the (i+1)th scan line shown in FIG. 1, in which i is an odd number. Moreover, there is no pixel unit between the second scan line 120 and the third scan line 120, that is, there is no pixel unit between the (i+1)th scan line and the (i+2) scan line, in which N is a positive integer greater than 1, and is an odd number and 1≦i<N.

As shown in FIG. 1, the first pixel unit 102 and the second pixel unit 104 have a mirroring structure with respect to each other generally. Each pixel of the first pixel units 102 and the second pixel units 104 includes a pixel electrode 160 and a common electrode 170. The pixel electrode 160 is insulatively disposed on the common electrode 170. A pattern of the common electrode 170 is not limited to be a crisscross as the drawing, and it may also be implemented to be other patterns. The pixel electrode 160 is electrically coupled to a data line 140 via a thin film transistor 110 which is well-known to a person skilled in the art, no further detail will be provided herein.

The N/2 auxiliary scan lines 125 are respectively disposed between an (i)th row of the first pixel units 102 and an (i+1)th row of the second pixel units 104. As shown in FIG. 2, specifically, a auxiliary scan line 125 is disposed between the first row of the first pixel units 102 and the second row of the second pixel units 104, and a auxiliary scan line 125 is disposed between the third row of the first pixel units 102 and the fourth row of the second pixel units 104, and so on. It is worth mentioning that the auxiliary scan lines 125 and the scan line 120 are located at a same layer and insulatively intersect the data lines 140.

The switches 150 are disposed in the N/2 auxiliary scan lines 125 for controlling a conduction between the common electrode 170 and the pixel electrode 160 in the (i)th row of the first pixel units 102 and the (i+1)th row of the second pixel units 104, In the preferred embodiment, the switches 150 are a plurality of thin film transistors. Each thin film transistor has a gate 152, a source 154, a first drain 156, and a second drain 158. The gate 152 is implemented by the auxiliary scan line 125, The source 154, the first drain 156, and the second drain 158 are disposed on the auxiliary scan line 125. More specifically, the source 154 is electrically coupled to the common electrode 170 (designated as a first common electrode 172 for distinguishing) located on the (i)th row of the first pixel units 102 and to the common electrode 170 (designated as a second common electrode 174 for distinguishing) located on the (i+1)th row of the second pixel units 104. In addition, the first drain 156 is electrically coupled to the pixel electrode 160 (designated as a first pixel electrode 162 for distinguishing) located on the (i)th row of the first pixel units 102, and the second drain 158 is electrically coupled to the pixel electrode 160 (designated as a second pixel electrode 164 for distinguishing) located on the (i+1)th row of the second pixel units 104.

The following will explain that the auxiliary scan lines 125 perform the black frame insertion process for the first pixel units 102 and the second pixel units 104. When the gate 152 is at high level, the switch 150 is conducted. Signals of the first common electrode 172 and the second common electrode 174 are simultaneously inputted the first pixel electrode 162 and the second pixel electrode 164. Therefore, the first pixel unit 102 and the second pixel unit 104 respectively corresponding to the first pixel electrode 162 and the second pixel electrode 164 are black for achieving the black frame insertion process.

The black frame insertion method utilized by the LCD device of the preferred embodiment will be explained in detail in the following. Referring to FIG. 1 and FIG. 2, the LCD device comprises N scan lines 120, N rows of first pixel units 102 and second pixel units 104 alternately arranged, N/2 auxiliary scan lines 125 respectively disposed between an (i)th row of the first pixel units 102 and an (i+1)th row of the second pixel units 104, and a plurality of switches 150 being disposed in the N/2 auxiliary scan ones 125. Each pixel of the first pixel units 102 and the second pixel units 104 includes a pixel electrode 160 and a common electrode 170, in which N is a positive integer greater than 1, and i is an odd number and 1≦i<N. The descriptions of other elements have been explained as above mention, no further detail will be provided herein.

Referring to FIG. 3, FIG. 3 is a flow chart illustrating the black frame insertion method according to the preferred embodiment of the present invention. The method begins with step S10.

At step S10, the N scan lines 120 drive the alternately arranged N rows of the first pixel units 102 and the second pixel units 104 sequentially, so that the first pixel units 102 and the second pixel units 104 corresponding to the alternately arranged N rows of the first pixel units 102 and the second pixel units 104 display predetermined images. Referring to FIG. 4 and FIG. 5, FIG. 4 and FIG. 5 are schematic drawings illustrating the black frame insertion process of an active area according to one preferred embodiment of the present invention. For example, as shown in FIG. 4, the scan line 120 starts to drive the first row of the first pixel units 102, such that the first row of the first pixel units 102 show predetermined images, in which a driving position is indicated as a dashed arrow. Subsequently, as shown in FIG. 5, the scan line 120 drives the second row of the second pixel units 104, such that the second row of the second pixel units 104 show the predetermined images. The rest may be deduced by analogy, and the alternately arranged N rows of first pixel units 102 and second pixel units 104 are driven sequentially.

At step S20, as shown in FIG. 1, the N/2 auxiliary scan lines 125 sequentially drive the switches 150. When the auxiliary scan lines 125 disposed between the (i)th row of the first pixel units 102 and the (i+1)th row of the second pixel units 104 is driven, the common electrodes 170 and the pixel electrodes 160 located on the (i)th row of the first pixel units 102 and the (i+1)th row of the second pixel units 104 are conducted by the switches 150 thereon. Moments of driving the auxiliary scan lines 125 are later than moments of driving the scan lines 125.

In the preferred embodiment, the moment of driving the auxiliary scan line located between the (i)th row of the first pixel units 102 and the (i+1)th row of the second pixel units 104 is half a frame period later than the moments of driving the (i)th scan line 120.

Referring to FIG. 4 to FIG. 7, FIG. 4 and FIG. 5 are schematic drawings illustrating the black frame insertion process of an active area according to one preferred embodiment of the present invention. Using the (i)th row being the first row as an example, after driving the first row of the first pixel units 102, the active area 10 is shown in FIG. 6 after half the frame period, that is, before the ((N/2)+1)th row of the pixel units are driven completely. Subsequently, the auxiliary scan line 125 disposed between the first row of the first pixel units 102 and the second row of the second pixel units 104 is driven, so that the first row of the first pixel units 102 and the second row of the second pixel units 104 become black image simultaneously, as shown in FIG. 7. Then the auxiliary scan line 125 disposed between the third row of the first pixel units 102 and the fourth row of the second pixel units 104 is driven, and so on. It can be seen from the foregoing that the active area of the preferred embodiment has half a black frame substantially for achieving the black frame insertion effect.

In another preferred embodiment, the moment of driving the auxiliary scan line 125 located between the (i)th row of the first pixel units 102 and the (i+1)th row of the second pixel units 104 may be half the frame period later than the moments of driving the (i+1)th scan line 120. The description thereof may be referred as mentioned previously, no further detail will be provided herein.

In summary, the LCD device of the present invention has the N/2 auxiliary scan lines 125 for the signal of the common electrode 170 being inputted into the pixel electrode 160, thereby achieving the black frame insertion effect. Moreover, in accordance with the black frame insertion method of the present invention, after the (i)th row of the first pixel units 102 display the predetermined images, the (i)th auxiliary scan line 125 can be driven after the half frame period for performing the black frame insertion process of the (i)th row of the first pixel units 102 and the (i+1)th row of the second pixel units 104. It can be seen from the foregoing that the frame rate does not need to be increased, and the transitions of the grayscales of the pixels all start from the black grayscale voltage, which makes the twists of the liquid crystal molecules more stable so as to solve the above-mentioned problem.

While the preferred embodiments of the present invention have been illustrated and described in detail, various modifications and alterations can be made by persons skilled in this at The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A black frame insertion method for an LCD device, the LCD device comprising N scan lines, N rows of first pixel units and second pixel units alternately arranged, N/2 auxiliary scan lines respectively disposed between an (i)th row of the first pixel units and an (i+1)th row of the second pixel units, and a plurality of switches disposed in the N/2 auxiliary scan lines, each pixel of the first pixel units and the second pixel units comprising a pixel electrode and a common electrode, N being a positive integer greater than 1, and i being an odd number and 1≦i<N, characterized in that the black frame insertion method comprises:
driving the alternately arranged N rows of the first pixel units and the second pixel units sequentially through the N scan lines, so that the first pixel units and the second pixel units corresponding to the alternately arranged N rows of first pixel units and second pixel units display predetermined images, and
driving the switches sequentially through the N/2 auxiliary scan lines, when the auxiliary scan lines disposed between the (i)th row of the first pixel units and the (i+1)th row of the second pixel units is driven, the common electrodes and the pixel electrodes located on the (i)th row of the first pixel units and the (i+1)th row of the second pixel units being conducted by the switches thereon, such that the (i)th row of the first pixel units and the (i+1)th row of the second pixel units are black simultaneously, wherein a moment of driving the auxiliary scan lines located between the (i)th row of the first pixel units and the (i+1)th row of the second pixel units is later than a moment of driving the (i)th scan line.

2. The black frame insertion method for the LCD device according to claim 1, characterized in that the moment of driving the auxiliary scan line located between the (i)th row of the first pixel units and the (i+1)th row of the second pixel units is half a frame period later than the moments of driving the (i)th scan line.

3. The black frame insertion method for the LCD device according to claim 1, characterized in that the moment of driving the auxiliary scan line located between the (i)th row of the first pixel units and the (i+1)th row of the second pixel units is half a frame period later than the moments of driving the (i+1)th scan line.

4. The black frame insertion method for the LCD device according to claim 1, characterized in that the switches are a plurality of thin film transistors.

5. The black frame insertion method for the LCD device according to claim 4, characterized in that each of the thin film transistors has a gate, a source, a first drain, and a second drain, wherein the gate is the auxiliary scan line, and wherein the source, the first drain, and the second drain are disposed on the auxiliary scan line.

6. An LCD device, characterized in that, comprising:
N scan lines, N being a positive integer greater than 1;
N rows of first pixel units and second pixel units alternately arranged, each row of the first pixel units and each row of the second pixel units respectively corresponding to a scan line, each pixel of the first pixel units and the second pixel units comprising a pixel electrode and a common electrode;
N/2 auxiliary scan lines, respectively disposed between an (i)th row of the first pixel units and an (i+1)th row of the second pixel units, i being an odd number and 1≦i<N; and
a plurality of switches disposed in the N/2 auxiliary scan lines for controlling a conduction between the common electrode and the pixel electrode in the (i)th row of the first pixel units and the (i+1)th row of the second pixel units.

7. The device according to claim 6, characterized in that the switches are a plurality of thin film transistors.

8. The device according to claim 7, characterized in that each of the thin film transistors has a gate, a source, a first drain, and a second drain, wherein the gate is the auxiliary scan line, and wherein the source, the first drain, and the second drain are disposed on the auxiliary scan line.

9. The device according to claim 8, characterized in that the source is electrically coupled to the first common electrode located on the (i)th row of the first pixel units and to the second common electrode located on the (i+1)th row of the second pixel units.

10. The LCD device according to claim 9, characterized in that the first drain is electrically coupled to the first pixel electrode located on the (i)th row of the first pixel units, and the second drain is electrically coupled to the second pixel electrode located on the (i+1)th row of the second pixel units,

11. The LCD device according to claim 10, characterized in that signals of the first common electrode and the second common electrode are simultaneously inputted the first pixel electrode and the second pixel electrode when the gate is at a high level.

12. LCD device according to claim 11, characterized in that pixel units corresponding to the first pixel electrode and the second pixel electrode are black.

13. A black frame insertion method for an LCD device, the LCD device comprises N scan lines, N rows of first pixel units and second pixel units alternately arranged, N/2 auxiliary scan lines respectively disposed between an (i)th row of the first pixel units and an (i+1)th row of the second pixel units, and a plurality of switches disposed in the N/2 auxiliary scan lines, each pixel of the first pixel units and the second pixel units comprising a pixel electrode and a common electrode, N being a positive integer greater than 1, and i being an odd number and 1≦i<N, characterized in that the black frame insertion method comprises:
driving the alternately arranged N rows of the first pixel units and the second pixel units sequentially through the N scan lines, so that the first pixel units and the second pixel units corresponding to the alternately arranged N rows of first pixel units and second pixel units display predetermined images; and
driving the switches sequentially through the N/2 auxiliary scan lines, when the auxiliary scan lines disposed between the (i)th row of the first pixel units and the (i+1)th row of the second pixel units is driven, the common electrodes and the pixel electrodes located on the (i)th row of the first pixel units and the (i+1)th row of the second pixel units being conducted by the switches thereon, wherein moments of driving the auxiliary scan lines are later than moments of driving the scan lines.

14. The black frame insertion method for the LCD device according to claim 13, characterized in that the moment of driving the auxiliary scan line located between the (i)th row of the first pixel units and the (i+1)th row of the second pixel units is half a frame period later than the moments of driving the (i)th scan line.

15. The black frame insertion method for the LCD device according to claim 13, characterized in that the moment of driving the auxiliary scan line located between the (i)th row of the first pixel units and the (i+1)th row of the second pixel units is half a frame period later than the moments of driving the (i+1)th scan line.
